(19) United States
(12) Patent Application Publication
(10) Pub. No.: US 2026/0158787 A1
(43) Pub. Date: Jun. 11, 2026

(54) LIQUID DISCHARGE HEAD, LIQUID DISCHARGE DEVICE, LIQUID DISCHARGE APPARATUS, AND FUNCTIONAL COMPONENT

(71) Applicant: Kohei SAKURAI, Kanagawa (JP)

(72) Inventor: Kohei SAKURAI, Kanagawa (JP)

(21) Appl. No.: 19/398,139

(22) Filed: Nov. 24, 2025

(30) Foreign Application Priority Data
Dec. 11, 2024 (JP) 2024-216437

(51) Int. Cl. B41J 2/165; B41J 2/175; B41J 11/00; B41J 29/02

(52) U.S. Cl. CPC B41J 2/16502; B41J 2/175; B41J 11/007; B41J 29/02

(57) ABSTRACT

A liquid discharge head including: a head including: a nozzle plate having nozzles arrayed in a first direction to discharges a liquid, from the nozzles, in a second direction orthogonal to the first direction; and a frame including: a snap-fitted part; and a bonded part; and a cover attached to the frame of the head in the second direction, the cover including: a snap-fitting part fitted to the snap-fitted part of the frame of the head; a bonding part bonding to the bonded part of the frame of the head with adhesive, and the bonding part is positioned more internally than an inner circumferential face of the cover; and the bonding part is spaced apart from the snap-fitting part.

### CROSS-REFERENCE TO RELATED APPLICATION

This patent application is based on and claims priority pursuant to 35 U.S.C. § 119(a) to Japanese Patent Application No. 2024-216437, filed on Dec. 11, 2024, in the Japan Patent Office, the entire disclosure of which is hereby incorporated by reference herein.

### BACKGROUND

### Technical Field

The present embodiment relates to a liquid discharge head, a liquid discharge device, a liquid discharge apparatus, and a functional component.

### Related Art

A liquid discharge head includes a head that discharges a liquid and a cover attached to a frame of the head.

For example, as the liquid discharge head, there is a liquid discharge head in which the frame and the cover are bonded with an adhesive.

### SUMMARY

The present disclosure described herein provides a liquid discharge head including: a head including: a nozzle plate having nozzles arrayed in a first direction to discharges a liquid, from the nozzles, in a second direction orthogonal to the first direction; and a frame including: a snap-fitted part; and a bonded part; and a cover attached to the frame of the head in the second direction, the cover including: a snap-fitting part fitted to the snap-fitted part of the frame of the head; a bonding part bonding to the bonded part of the frame of the head with adhesive, wherein the bonding part is disposed, in a third direction orthogonal to the first direction and the second direction: positioned more internally than an outer circumferential face of the cover; and positioned more internally than the snap-fitting part of the cover snap-fitting to the snap-fitted part of the frame of the head.

The present disclosure described herein further provides a functional component including: a first part including a frame including: a snap-fitted part; and a bonded part; and a second part attached to the frame of the first part in a fitting direction, the second part including: a snap-fitting part fitted to the snap-fitted part of the frame of the first part; a bonding part bonding to the bonded part of the frame of the first part with adhesive, wherein the bonding part is disposed, in a direction orthogonal to the fitting direction: positioned more internally than an outer circumferential face of the second part; and positioned more internally than the snap-fitting part of the second part snap-fitting to the snap-fitted part of the frame of the first part.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is an explanatory external front view of a liquid discharge head of a first embodiment;

FIG. 2 is an explanatory external side view of the liquid discharge head;

FIG. 3 is an explanatory side sectional view of the liquid discharge head;

FIG. 4 is an enlarged explanatory view of a substantial part of the side sectional view of the liquid discharge head;

FIG. 5 is a schematic diagram of a part related to bonding in FIG. 4;

FIG. 6 is an explanatory view of a state of snap-fit joint of the liquid discharge head;

FIGS. 7A to 7C are explanatory views of a frame of the liquid discharge head;

FIGS. 8A to 8C are explanatory views of a cover of the liquid discharge head;

FIGS. 9A and 9B are explanatory views of an inner surface side of a cover of the liquid discharge head;

FIGS. 10A to 10C are explanatory views of a shape of a snap-fit hook;

FIGS. 11A and 11B are explanatory views of a relationship between a thickness of each part of the snap-fit hook and easiness of deformation;

FIGS. 12A to 12D are explanatory views of a liquid discharge head of a second embodiment;

FIG. 13 is an explanatory view of the liquid discharge head;

FIG. 14 is an explanatory view of a liquid discharge head of a third embodiment;

FIGS. 15A and 15B are explanatory views of a structure of the liquid discharge head and a comparative example;

FIG. 16 is a comparative explanatory view of bonding strength between the liquid discharge head and a comparative example;

FIG. 17 is an explanatory view of a liquid discharge head of a fourth embodiment;

FIG. 18 is an explanatory view of a liquid discharge apparatus;

FIG. 19 is an explanatory side view of a substantial part of the liquid discharge apparatus;

FIG. 20 is an explanatory plan view of the substantial part of the liquid discharge device; and

FIG. 21 is an explanatory front view of another liquid discharge device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

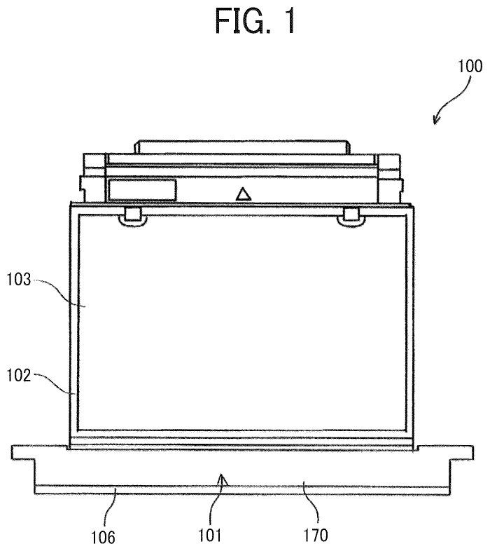

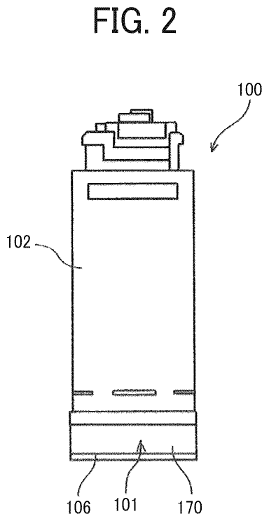

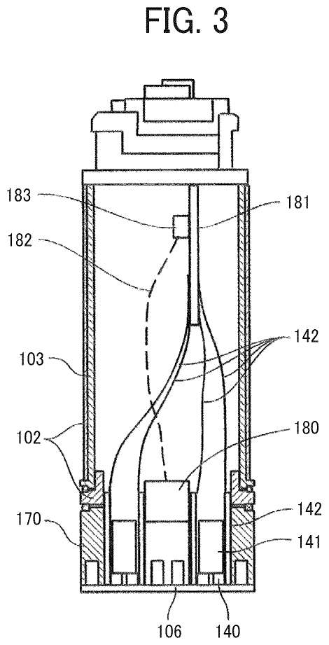

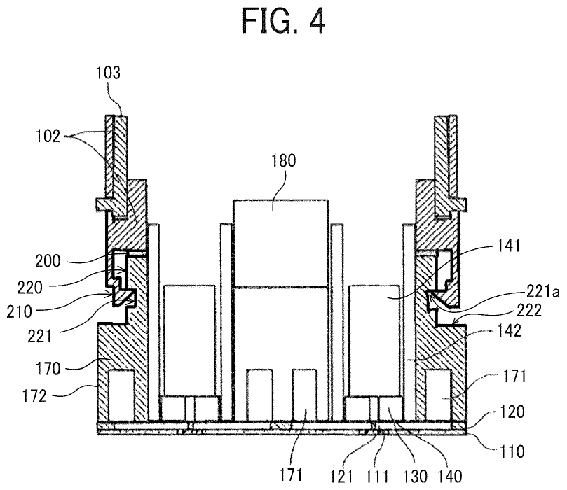

Hereinafter, an embodiment in which the present embodiment is applied to a liquid discharge head of an inkjet recording apparatus as an image forming apparatus, which is a liquid discharge apparatus, will be described. FIG. 1 is an explanatory external front view of a liquid discharge head of a first embodiment, FIG. 2 is an explanatory external side view of the liquid discharge head, FIG. 3 is an explanatory side sectional view of the liquid discharge head, and FIG. 4 is an enlarged explanatory view of a substantial part of the side sectional view.

As illustrated in FIGS. 1 and 2, a liquid discharge head 100 includes a head 101 that discharges a liquid, a cover 102, which is an exterior cover attached to a frame 170 of the head 101, and a heat sink 103 as a heat dissipation member attached to the cover 102. The cover is referred to also as “exterior member”.

As illustrated in FIG. 4, the head 101 includes a nozzle plate 110, an actuator board 106 including a channel plate 120, a diaphragm member 130, and a piezoelectric element 140, and a frame 170. The nozzle plate 110 includes multiple nozzles 111 to discharge a liquid. In the illustrated example, there are four nozzle rows in which the multiple nozzles 111 are arrayed.

The channel plate 120 forms a channel such as a pressure chamber 121 leading to the nozzle 111. The diaphragm member 130 forms a recoverably deformable wall surface of the pressure chamber 121. The piezoelectric element 140 is fixed to the base member 141, and a distal end thereof is bonded and fixed to a surface of the diaphragm member 130 on a side opposite to the pressure chamber 121.

The frame 170 is a housing also serving as a common channel member, and forms a common channel 171 leading to the pressure chamber 121. The frame 170 is made of SUS, for example. The frame 170 is provided with a PCB board 180 serving as an electric and electrical unit including a control mechanism for discharging a liquid. The frame 170 of the head 101 is attached to the cover 102 that covers the PCB board 180 and the piezoelectric element 140. The cover 102 can be formed of, for example, a PPT resin.

As illustrated in FIG. 3, a relay board 181 is disposed inside the cover 102, and a relay 182 provided on the relay board 181 and the PCB board 180 are coupled to each other via a wiring member 183. The relay board 181 and each piezoelectric element 140 are coupled to each other via a wiring member 142 such as a flexible wiring board, and the PCB board 180 and each piezoelectric element 140 are coupled to each other.

A heat sink 103 as a heat dissipation member is attached to the cover 102. The heat sink 103 can be formed of a metal member and a resin such as a polycarbonate resin having a high thermal conductivity.

Next, bonding of the frame 170 and the cover 102, which is a substantial part in the present embodiment, will be described. As illustrated in FIG. 4, the frame 170 and the cover 102 are bonded to each other by an adhesive 200. The adhesive 200 is applied to the frame 170 using a dispenser. The adhesive to be used is preferably an ink resistant adhesive, and examples thereof include an epoxy resin.

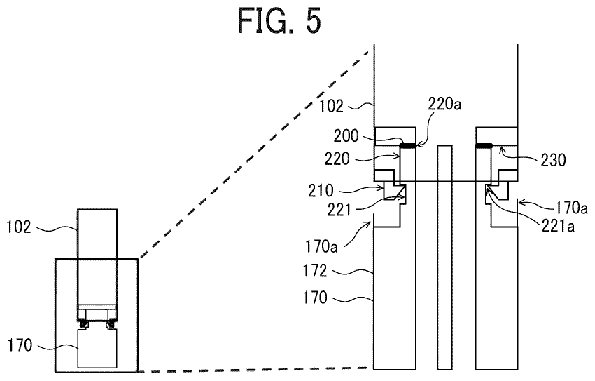

In addition to adhesive bonding, they are joined by snap-fit engagement by a snap-fit hook 210 as an engaging cover part provided on the cover 102 and an engaging recess 221 as an engaging frame part with which this is engaged. A shape of the engaging frame part may be a through hole shape instead of the recess. An adhesive bonding point is in an inner peripheral part of the cover 102 and is a point away from a snap-fit engaging point 221a toward an inner back side of the cover 102. A position of the adhesive 200 is also illustrated in FIG. 5. The snap-fit hook 210 is referred to also as a “snap-fitting part”, and the engaging recess 221 is referred to also as a “snap-fitted part”.

FIG. 5 is a schematic diagram of a part related to bonding in FIG. 4. The frame 170 includes a projection 220 extending from a base 172 along an outer peripheral shape line 170a inside the outer peripheral shape line 170a (that is, with a narrow width) at a point facing the cover 102. The projection 220 protrudes from a base 172 and extends upward toward the cover 102. The projection 220 includes the engaging recess 221 on an outer peripheral side surface at a point away from a projection distal end face 220a. The frame 170 has a step 222 at which a thickness of a wall of the frame decreases from the base to the projection 220.

The cover 102 includes the snap-fit hook 210 as the engaging cover part that is snap-fit engaged with the engaging recess 221, and an adhesive abutment part 230 that abuts the projection distal end face 220a in a snap-fit engaging state with the frame 170 and is adhesively bonded thereto. The exterior cover is provided with at least two or more snap-fits facing each other.

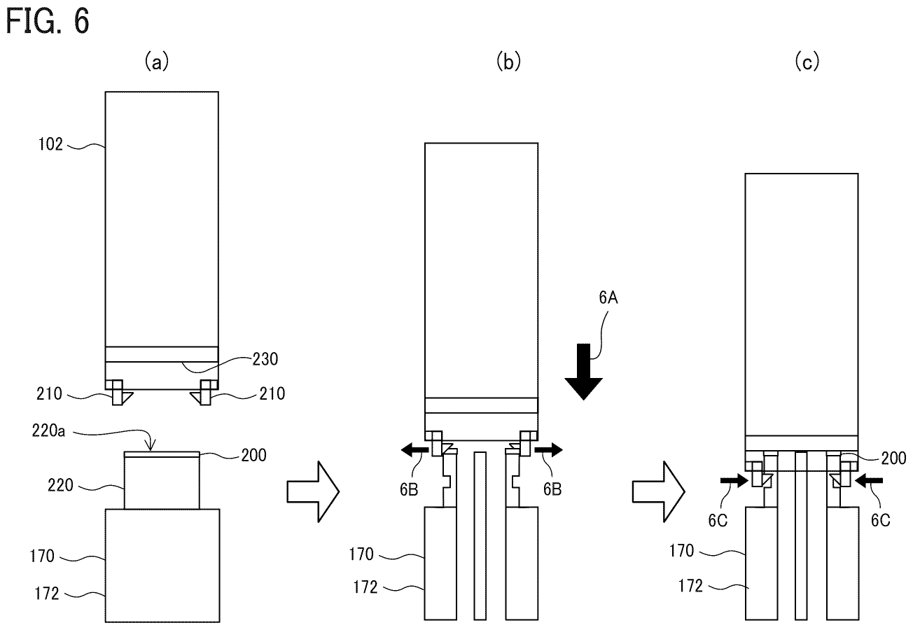

FIG. 6 is an explanatory view of a state of snap-fit joint. When bonding the cover 102 and the frame 170, the both members are relatively brought close to each other as indicated by arrow 6A. When the snap-fit hook 210 comes into contact with the frame 170, the snap-fit hook 210 opens while being elastically deformed as indicated by arrow 6B, and pushing proceeds in this state. When the snap-fit hook 210 fits in the engaging recess 221 of the frame 170, the snap-fit hook 210 closes to lock as indicated by arrow 6C.

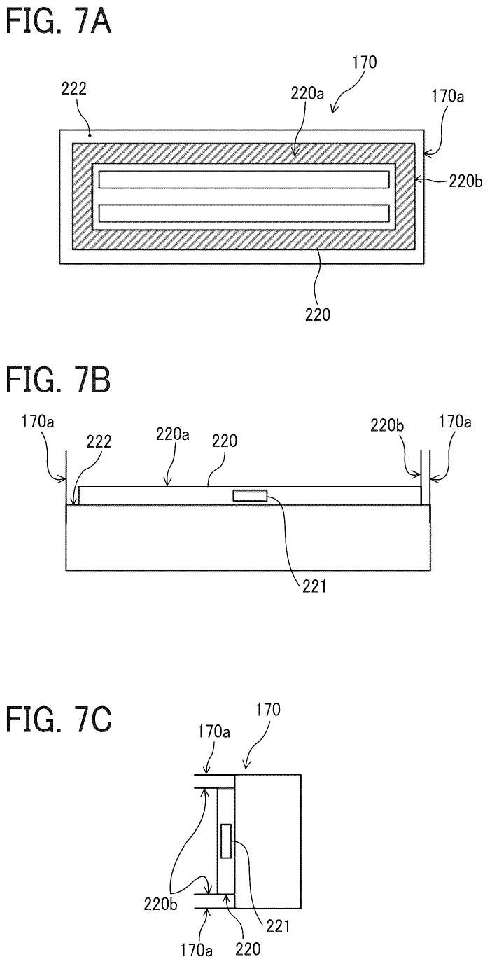

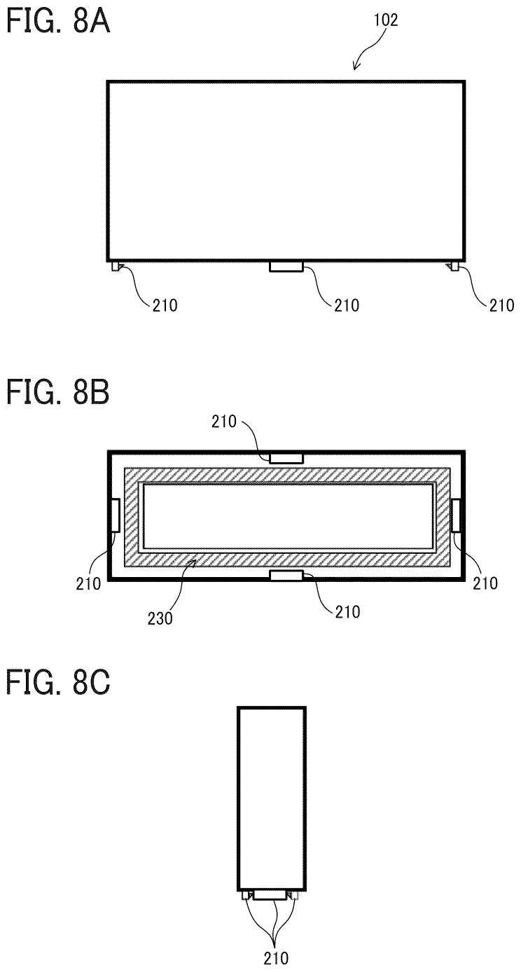

With reference to FIGS. 7A to 8C, an adhesive application range and points where a shaped part for snap-fit joint is formed will be described. FIGS. 7A to 7C are explanatory views of the frame 170 in which FIG. 7A is an explanatory front view when a surface facing the cover 102 of the frame 170 is made a front surface, FIG. 7B is an explanatory bottom view at that time, and FIG. 7C is an explanatory right side view at that time. The outer peripheral shape line 170a is the outer peripheral shape line of the frame 170 when the frame 170 is seen in a relative movement direction at the time of bonding.

The projection 220 extends over an entire circumference along the outer peripheral shape line 170a, and an adhesive is applied to an entire surface of the projection distal end face 220a. The projection 220 may be partially omitted in place of being formed over an entire circumference or the adhesive application may be partially performed, but it is preferable to form the projection 220 or apply the adhesive over an entire circumference from the viewpoint of preventing entry of ink mist. The engaging recesses 221 are formed on four sides, respectively, at points where long sides are opposed to each other and short sides are opposed to each other.

FIGS. 8A to 8C are explanatory views of the cover 102 in which FIG. 8A is an explanatory front view when a side wall of the cover 102 is on the front, FIG. 8B is an explanatory bottom view at that time, and FIG. 8C is an explanatory right side view at that time. The snap-fit hook 210 is formed integrally with the cover by molding so as to protrude downward from a lower end of the cover 102. Formed positions are located at four points corresponding to the engaging recesses 221 of the frame 170.

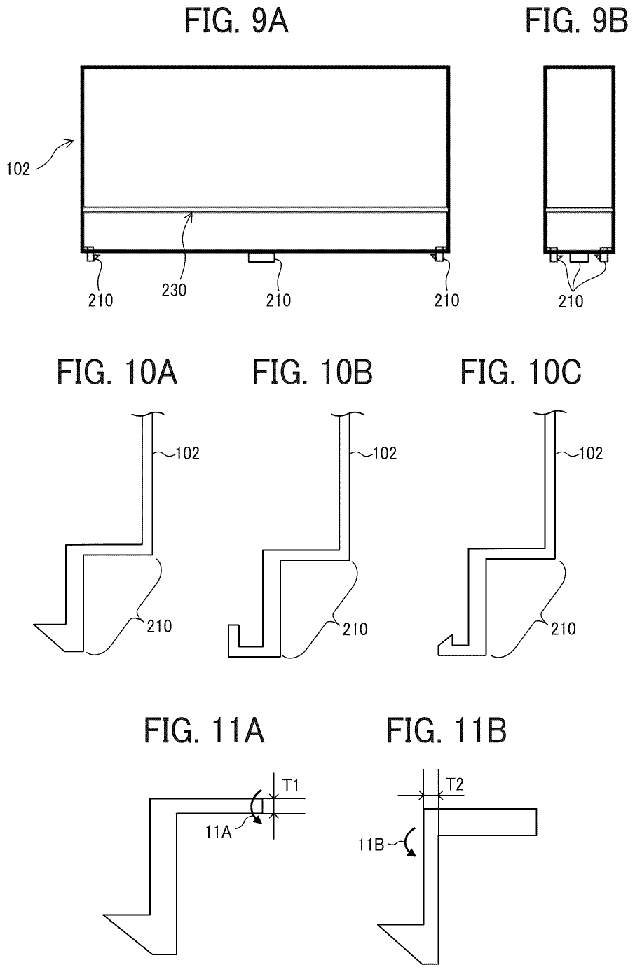

FIGS. 9A and 9B are explanatory views of an inner surface side of the cover 102. FIG. 9A is an explanatory view of a side wall inner surface, and FIG. 9B is an explanatory view of an end wall inner surface. An adhesive abutment part 230 on which the projection distal end face 220a of the frame 170 abuts is formed on inner wall surface parts. It is preferable that the projection 220 is formed over the entire circumference, and the adhesive abutment part 230 is also formed over the entire circumference so as to be able to abut the projection 220 over the entire circumference.

FIGS. 10A to 10C are explanatory views of the shape of the snap-fit hook 210 depending on whether an engaging partner has a recess shape or a through hole shape. In a case where a part in which the snap-fit hook 210 is fitted in the engaging recess 221 of the frame 170 is the engaging recess 221, the shape of the snap-fit hook 210 is preferably a shape having a tapered hook as illustrated in FIG. 10A, and in a case of the through hole, a U-shaped shape or a barbed shape as illustrated in FIG. 10B or FIG. 10C is preferable.

FIGS. 11A and 11B are explanatory views of a relationship between a thickness of each part of the snap-fit hook 210 and easiness of deformation. As illustrated in FIGS. 11A and 11B, directions in which deformation is likely to occur in a case where the thickness is reduced such as thicknesses T1 and T2 are indicated by arrows 11A and 11B. It is preferable to reduce the thickness of an appropriate point according to the direction in which the deformation easily occurs.

As described above, according to the liquid discharge head of the first embodiment, since the frame 170 and the cover 102 are joined by snap-fit engagement and adhesive bonding, bonding strength can be increased as compared with a case of bonding only by adhesive bonding. Moreover, since the adhesive bonding point is in the inner peripheral part of the cover 102 and is a point away from the snap-fit engaging point 221a toward the inner back side of the cover 102, the adhesive of an adhesive bonding part is hardly broken by a liquid or mist thereof. Even if mist of a liquid such as ink adheres to the frame 170 and is transmitted on a surface thereof to enter the inside of the cover through a gap between the frame 170 and the cover 102 at the snap-fit engaging point, there is a distance on a path along the inner surface of the cover 102 and there also is a space on the inner surface, so that it is possible to make it difficult to enter the adhesive bonding point by liquid wet-spreading. Even if wet-spreading occurs on the inner surface of the cover, entry can be suppressed by the distance.

Since the projection, the distal end face of which is the bonding point, is located inside the outer peripheral shape line 170a of the frame 170, a space of a dimensional difference between an outer peripheral shape line 220b of the projection 220 and the outer peripheral shape line 170a of the frame 170 can be used for accommodating a wall thickness of the snap-fit hook 210 and the cover 102, and an outer shape of the cover 102 can be downsized.

The projection may extend over an entire circumference or partially inside the outer peripheral shape line 170a at a point facing the cover 102. In a case where this extends partially, it is preferable to extend the projections at points forming a pair facing (opposite to) each other across the center. Although the hook is formed on the cover, this may be formed on the frame instead, and in this case, a hook engaging part is formed on the cover.

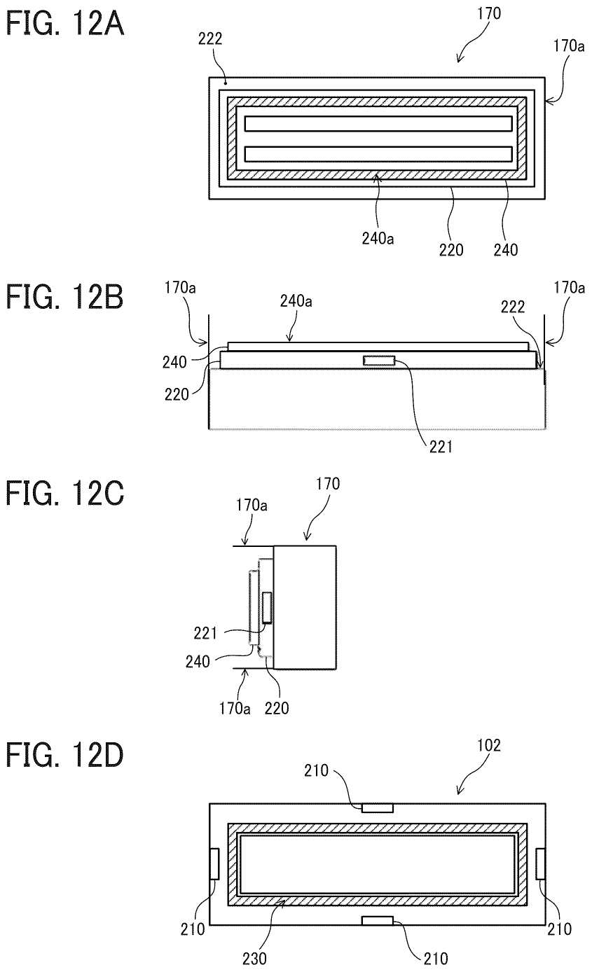

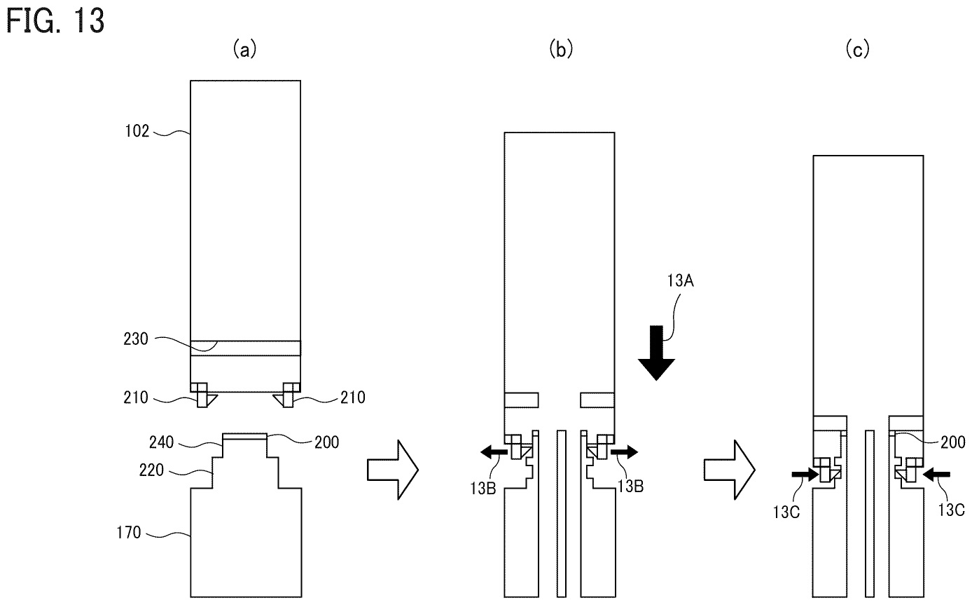

Next, a liquid discharge head of a second embodiment will be described with reference to FIGS. 12A to 13C. FIGS. 12A, 12B, 12C, and 12D are explanatory views corresponding to FIGS. 7A, 7B, 7C, and 8B of the liquid discharge head of the first embodiment. FIG. 13 is an explanatory view of the liquid discharge head of the second embodiment corresponding to FIG. 6 of the liquid discharge head of the first embodiment.

The liquid discharge head 100 of the second embodiment is different from that of the first embodiment in that a two-stage projection with a larger projection amount on an inner side is used in place of the projection 220 of the frame 170. The engaging recess 221 is included on the outer peripheral side surface of an outer first-stage projection 220 with a smaller projection amount, and a distal end face 240a of an inner second-stage projection 240 with a larger projection amount abuts the adhesive abutment part 230 of the cover 102. The adhesive abutment part 230 of the cover 102 is formed at a position abutting the distal end face 240a of the inner second-stage projection 240. The other points are the same as those of the liquid discharge head 100 of the first embodiment.

By setting a width between two points of an outer edge of the distal end face of the second-stage projection facing each other to be smaller than a distance between a pair of hook distal ends of the snap-fit hooks 210 corresponding thereto, the snap-fit hooks 210 can be prevented from coming into contact with the adhesive on the distal end face of the projection of the frame 170 when the cover 102 is bonded to the frame 170. With the two-stage structure of the projection, the snap-fit hook 210 does not come into contact with an adhesive application part (the second stage of the projection) on the upper surface of the projection of the frame when the cover 102 is bonded to the frame 170, and the snap-fit hook 210 comes into contact with the first stage of the projection on which the adhesive is not applied, so that bonding can be easily performed.

When the cover 102 moves downward toward the frame 170 in a downward direction 13A, the snap-fit hooks 210 come into contact with the projection of the frame 170. The snap-fit hooks 210 widen and move in a direction of arrow 13B, and then narrow and move in a direction of arrow 13C to engage with the engaging recess 221.

Even in a case of the one-stage projection as in the first embodiment or in a case of a uniform height without forming the projection itself at a point facing the cover 102 in the frame 170, if the width of the adhesive application range is set to be smaller than the distance between the pair of hook distal ends, it is possible to avoid the snap-fit hook 210 from coming into contact with the adhesive, but since difficulty in adjusting the application width increases, it is preferable to make two stages or three or more stages as in the present embodiment.

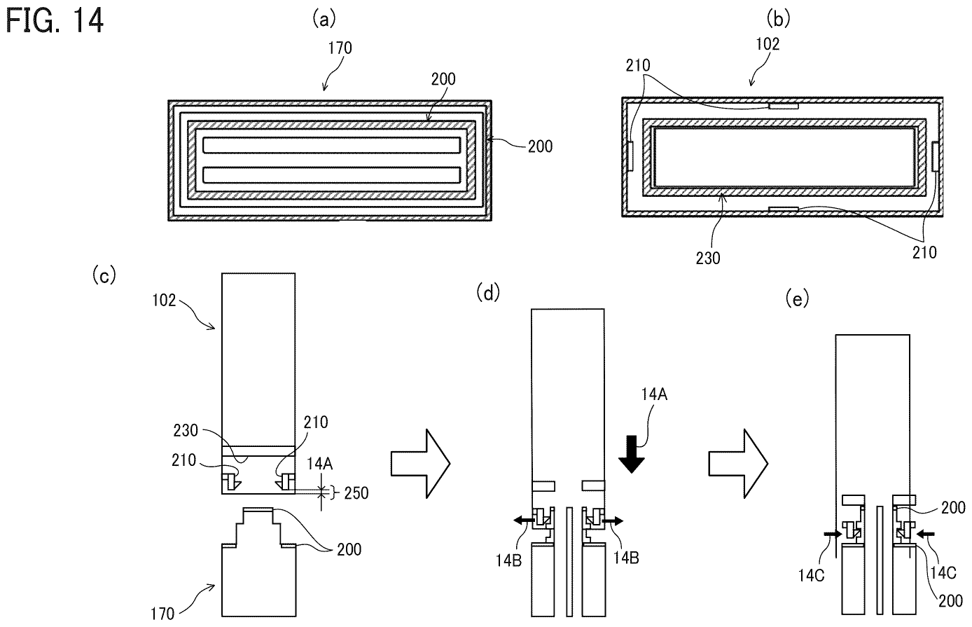

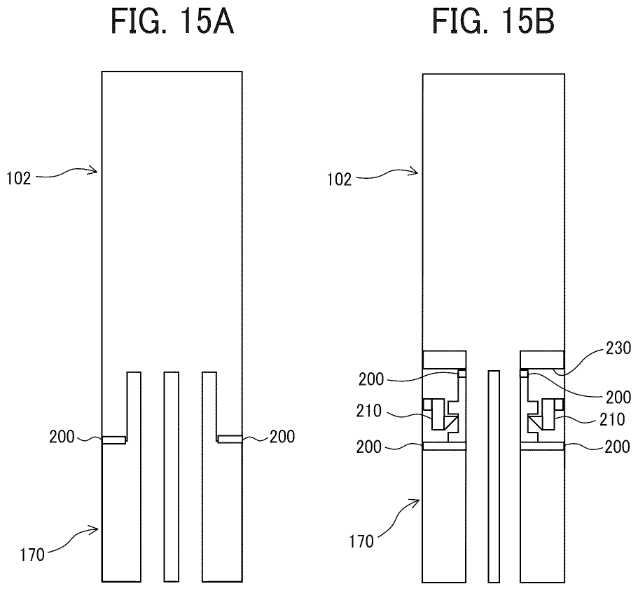

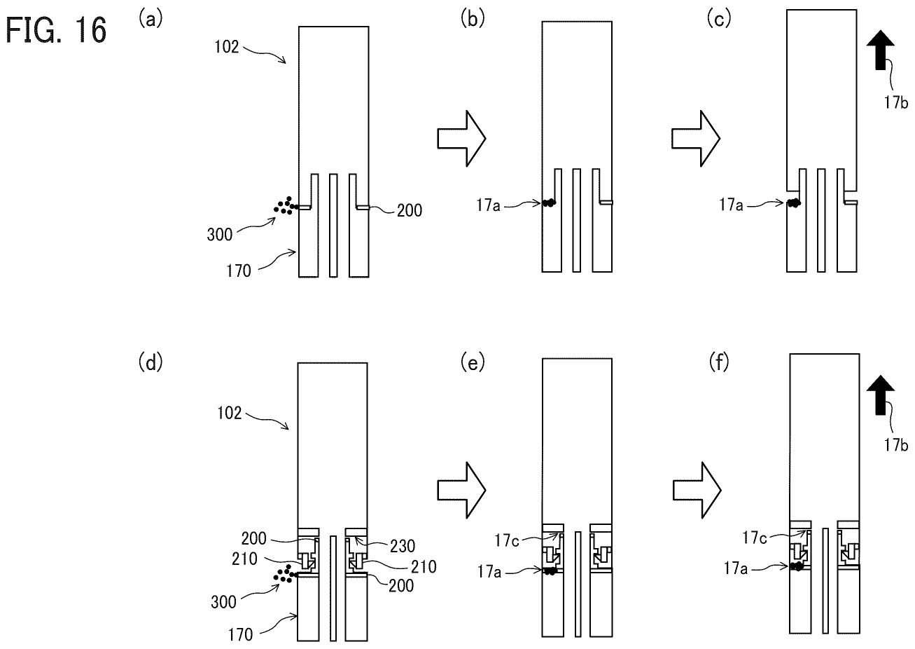

Next, a liquid discharge head of a third embodiment will be described with reference to FIG. 14. FIG. 14 is an explanatory view corresponding to FIGS. 12A, 12D, and 13 of the liquid discharge head of the second embodiment. FIGS. 15A and 15B are comparative explanatory views of a bonding point between a comparative example in which the frame 170 and the cover 102 are bonded only by adhesive bonding and the liquid discharge head of the third embodiment. FIG. 16 is a comparative explanatory view of bonding strength between the same comparative example and the liquid discharge head of the third embodiment.

The liquid discharge head 100 of the third embodiment is different from that of the second embodiment in that the cover 102 includes an extension part 250 extending toward the frame 170 from the distal end of the snap-fit hook 210 (refer to FIG. 14(c)), and the extension part 250 is also adhesively bonded to the frame 170. The adhesive 200 is also applied to a facing point of the frame 170 on which the distal end face 250a (refer to FIG. 14(b)) of the extension part 250 abuts. In FIG. 14(a), an application region of the adhesive 200 is hatched (the same applies to the first and second embodiments). The other points are the same as those of the liquid discharge head 100 of the second embodiment.

As illustrated in FIGS. 15A and 15B, there are two adhesive bonding points (more than comparative example), and furthermore, snap-fit joint is also performed. It is possible to further enhance an effect of preventing entry of a liquid or mist into the cover 102 and bonding strength.

FIG. 16(a) to 16(c) illustrate performance of the liquid discharge head of the comparative example in FIG. 15A, and FIG. 16(d) to 16(f) illustrate performance of the liquid discharge head of the third embodiment. In the head of the comparative example, the cover 102 and the frame 170 are bonded only by adhesive bonding, and an adhesive bonding part 17a is exposed. Therefore, when an ink splash 300 comes into contact with the adhesive bonding part 17a, the adhesive is broken and bonding strength is deteriorated, and when a force 17b is applied from the outside, the cover is peeled off.

In the liquid discharge head 100 of the third present embodiment, since there is the snap-fit hook 210, the cover 102 is not detached even if the ink comes into contact with the adhesive bonding part, the adhesive bonding part 17c is also provided inside the cover 102, and there is a distance and a space on the inner surface between the snap-fit hook 210 and the adhesive bonding part 17c. As a result, spreading of the ink can be suppressed, and even if the ink enters the cover 102, the ink hardly reaches the adhesive bonding part 17c, and a sealing function is hardly lost. Therefore, even if the ink splash 300 comes into contact, a head failure can be prevented, which is more excellent than the comparative example.

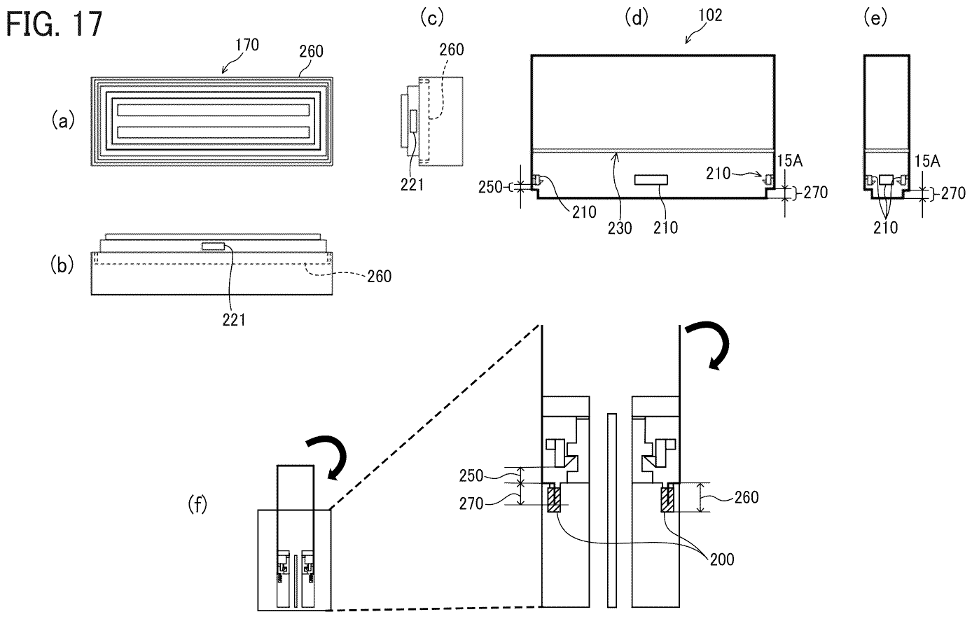

Next, a liquid discharge head of a fourth embodiment will be described with reference to FIG. 17(a) to 17(f). FIG. 17(a), 17(b), and 17(c) are explanatory views corresponding to FIGS. 12A, 12B, and 12C of the liquid discharge head of the second embodiment. FIG. 17(d) and 17(e) are explanatory views of the inner surface side of the cover 102. FIG. 17(d) is an explanatory view of a side wall inner surface, and FIG. 17(e) is an explanatory view of an end wall inner surface. FIG. 17(f) is an enlarged explanatory view of a substantial part.

In the liquid discharge head 100 of the fourth embodiment, the cover 102 includes extension parts (250 and 270) extending toward the frame 170 from the distal ends of the snap-fit hooks 210 as compared with that of the second embodiment (refer to FIG. 17(d) and 17(e) ). The distal end of the extension parts (250 and 270) is fitted in a fitting recess 260 on the frame 170 (refer to FIG. 17(f)). Since an outer peripheral part of the cover 102 is accommodated in the fitting recess 260 in the frame 170, this is strong against a force in a rotation direction, and bonding strength is improved. Ink entry can be further prevented by securing the cover outer peripheral part accommodated in the recess with the adhesive.

The liquid discharge head of each of the above-described embodiments has the following advantages. That is, in adhesive bonding, bonding strength depends on performance of the adhesive, and there is a variation in strength due to a cured state due to thermal curing, and strength is weaker than that of mechanical bonding. In contrast, in mechanical bonding such as bolt joint, bonding strength varies depending on a torque value at the time of bolt joint, and a risk of foreign matter generation is high. It is necessary to provide a space for bolt joint, which increases the size. In each embodiment of the invention of the present application, these disadvantages can be solved by skillfully combining adhesive bonding and snap-fit joint.

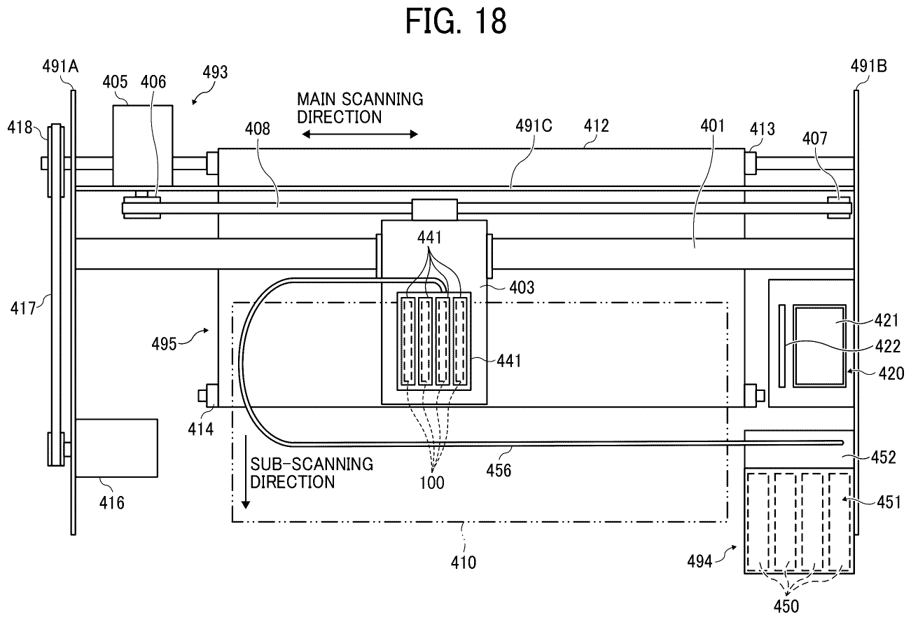

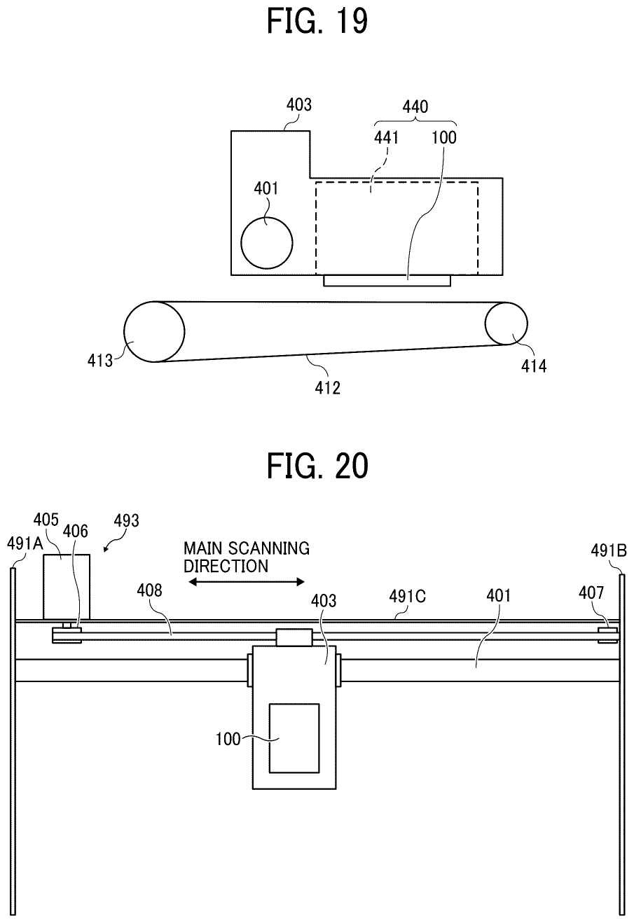

An example of a liquid discharge apparatus according to the present embodiment is described below with reference to FIGS. 18 and 19. FIG. 18 is an explanatory plan view of a substantial part of the apparatus, and FIG. 19 is an explanatory side view of the substantial part of the apparatus.

The apparatus is a serial type apparatus, and a carriage 403 reciprocally moves in a main scanning direction by a main scan moving mechanism 493. The main scan moving mechanism 493 includes a guide 401, a main scan motor 405, a timing belt 408, and the like. The guide 401 is bridged between a left-side plate 491A and a right-side plate 491B to moveably hold the carriage 403. The main scanning motor 405 reciprocates the carriage 403 in the main scanning direction via the timing belt 408 looped around a drive pulley 406 and a driven pulley 407.

The carriage 403 mounts the liquid discharge device 440 obtained by integrating the liquid discharge head 100 according to the present embodiment and a head tank 441. The liquid discharge head 100 of the liquid discharge device 440 discharges color liquids of, for example, yellow (Y), cyan (C), magenta (M), and black (K). The liquid discharge head 100 includes a nozzle array including multiple nozzles arrayed in a sub scanning direction perpendicular to the main scanning direction and is mounted so that a discharge direction is downward.

The liquids stored in liquid cartridges 450 are supplied to the head tank 441 by a supply mechanism 494 to supply the liquid stored outside the liquid discharge head 100 to the liquid discharge head 100.

The supply mechanism 494 includes a cartridge holder 451 which is a loading device to mount the liquid cartridges 450, a tube 456, and a liquid feed unit 452 including a liquid feed pump. The liquid cartridge 450 is detachably attached to the cartridge holder 451. The liquid feed unit 452 feeds the liquid from the liquid cartridge 450 to the head tank 441 via the tube 456.

The liquid discharge apparatus further includes a conveyance mechanism 495 to convey a sheet 410. The conveyance mechanism 495 includes a conveyance belt 412 as a conveyance unit and a sub scanning motor 416 to drive the conveyance belt 412.

The conveyance belt 412 attracts the sheet 410 and conveys the sheet 410 at a position facing the liquid discharge head 100. The conveyance belt 412 is an endless belt looped around a conveyance roller 413 and a tension roller 414. Attraction can be performed by, for example, electrostatic attraction or air suction.

The conveyance belt 412 circumferentially moves in the sub scanning direction as the conveyance roller 413 is rotationally driven by the sub scanning motor 416 via a timing belt 417 and a timing pulley 418.

At one side in the main scanning direction of the carriage 403, a maintenance mechanism 420 to maintain the liquid discharge head 100 in good condition is disposed on a lateral side of the conveyance belt 412.

The maintenance mechanism 420 includes, for example, a cap 421 to cap a nozzle surface (a surface on which a nozzle is formed) of the liquid discharge head 100, a wiper 422 to wipe the nozzle surface.

The main scanning moving mechanism 493, the supply mechanism 494, the maintenance mechanism 420, and the conveyance mechanism 495 are mounted onto a housing including the left-side plate 491A, the right-side plate 491B, and a rear-side plate 491C.

In the liquid discharge apparatus having the above-described configuration, the sheet 410 is fed and attracted onto the conveyance belt 412 and conveyed in the sub scanning direction as the conveyance belt 412 circumferentially moves.

The liquid discharge head 100 is driven in response to image signals while the carriage 403 moves in the main scanning direction, to discharge liquid to the sheet 410 stopped, thus forming an image on the sheet 410.

As described above, the apparatus includes the liquid discharge head according to the present embodiment, thus allowing stable formation of high-quality images.

Next, another example of the liquid discharge device according to the present embodiment is described with reference to FIG. 20. FIG. 20 is an explanatory plan view of a substantial part of the liquid discharge device.

The liquid discharge device includes a housing, the main scan moving mechanism 493, the carriage 403, and the liquid discharge head 100 among components of the liquid discharge apparatus. The left-side plate 491A, the right-side plate 491B, and the rear-side plate 491C form the housing.

The liquid discharge device may further include at least one of the maintenance mechanism 420 or the supply mechanism 494, which may be attached to the right-side plate 491B of the liquid discharge device.

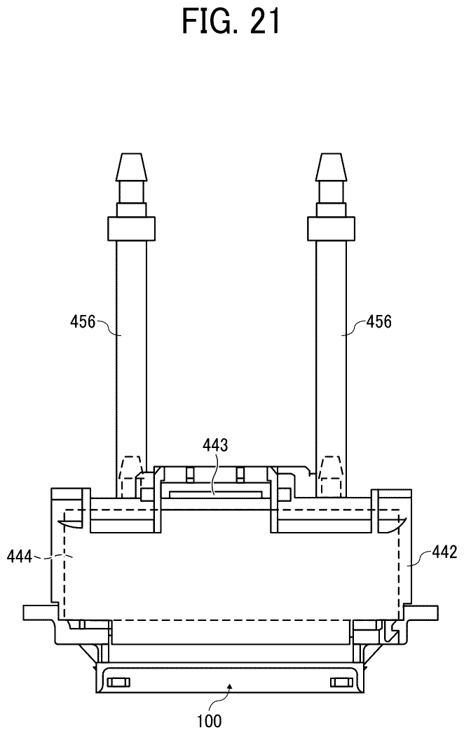

Next, still another example of the liquid discharge device according to the present embodiment is described with reference to FIG. 21. FIG. 21 is an explanatory front view of the liquid discharge device.

The liquid discharge device includes a liquid discharge head 100 and a tube 456 coupled to a liquid supply unit 444 of the liquid discharge head 100.

The liquid discharge device includes an exterior cover 442 as illustrated in FIG. 21. The liquid supply unit 444 can also include a head tank 441. A reference numeral 443 in FIG. 21 denotes a connector electrically connected to an electrical board.

In the present application, the “liquid discharge apparatus” includes the liquid discharge head or the liquid discharge device and drives the liquid discharge head to discharge a liquid. The liquid discharge apparatus may be, for example, an apparatus capable of discharging a liquid to a material to which liquid can adhere or an apparatus to discharge liquid toward gas or into liquid.

The “liquid discharge apparatus” may further include devices relating to feeding, conveying, and ejecting of the material onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “material onto which liquid can adhere” represents a material onto which liquid is at least temporarily adhered, a material onto which liquid is adhered and fixed, or a material into which liquid is adhered to permeate. Specific examples of the “material onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “material onto which liquid can adhere” includes any material to which liquid adheres, unless otherwise specified.

Examples of materials of the “material onto which liquid can adhere” include any materials to which liquid can adhere even temporarily, such as paper, thread, fiber, fabric, leather, metal, plastic, glass, wood, ceramic, construction materials (e.g., wallpaper or floor material), and cloth textile.

Examples of the “liquid” include ink, treatment liquid, DNA sample, resist, pattern material, binder, fabrication liquid, and solution or liquid dispersion containing amino acid, protein, or calcium.

The “liquid discharge apparatus” may be an apparatus to move the liquid discharge head and the material onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the “liquid discharge apparatus” further include a treatment liquid applying apparatus that discharges a treatment liquid onto a sheet to apply the treatment liquid to the surface of the sheet, for reforming the surface of the sheet, and an injection granulation apparatus that injects a composition liquid, in which a raw material is dispersed in a solution, through a nozzle to granulate fine particles of the raw material.

The “liquid discharge device” refers to a liquid discharge head integrated with functional components or mechanisms, i.e., an assembly of components related to liquid discharge. For example, the “liquid discharge device” includes a combination of the liquid discharge head with at least one of a head tank, a carriage, a supply mechanism, a maintenance mechanism, and a main scan moving mechanism to form a single unit.

Examples of the “single unit” include a combination in which the liquid discharge head and one or more functional components and mechanisms are secured to each other through, e.g., fastening, bonding, or engaging, and a combination in which one of the liquid discharge head and the functional components and mechanisms is movably held by another. The liquid discharge head may be detachably attached to the functional components or mechanisms.

For example, as a liquid discharge device, there is a liquid discharge device in which the liquid discharge head and the head tank form a single unit, as in the liquid discharge device 440 illustrated in FIG. 19. Alternatively, the liquid discharge head and the head tank coupled (connected) with a tube or the like may form the liquid discharge device as a single unit. A unit including a filter may be added at a position between the head tank and the liquid discharge head of the liquid discharge device.

In another example, the liquid discharge head and the carriage may form the liquid discharge device as a single unit.

In still another example, the liquid discharge device includes the liquid discharge head movably held by a guide that forms a part of the scan moving mechanism, so that the liquid discharge head and the scan moving mechanism form a single unit. As illustrated in FIG. 20, the liquid discharge head, the carriage, and the main scan moving mechanism may form the liquid discharge device as a single unit.

In still another example, a cap that forms a part of the maintenance mechanism may be secured to the carriage onto which the liquid discharge head is mounted so that the liquid discharge head, the carriage, and the maintenance mechanism form a single unit to form the liquid discharge device.

Further, in still another example, as illustrated in FIG. 21, the liquid discharge head is coupled to tubes so that the liquid discharge head and the supply mechanism are integrated as a single liquid discharge device.

The main scan moving mechanism may be a guide only. The supply mechanism may be a tube(s) only or a loading unit only.

The pressure generator used in the “liquid discharge head” is not limited to a particular type of pressure generator. The pressure generator is not limited to the piezoelectric actuator (or a laminated piezoelectric element) described in the above-described embodiments, and may be, for example, a thermal actuator that employs an electrothermal transducer element, such as a thermal resistor, or an electrostatic actuator including a diaphragm and opposed electrodes.

The terms “image formation”, “recording”, “printing”, “image printing”, and “fabricating” used herein may be used synonymously with each other.

Although the preferred embodiment of the present embodiment has been described above, the present embodiment is not limited to the specific embodiment, and various modifications and changes can be made within the scope of the gist of the present embodiment recited in claims unless otherwise limited in the above description.

For example, the present embodiment is not limited to the liquid discharge head, and can also be applied to joining in another exterior part including a functional member for exhibiting a function and an exterior member covering the functional member, in which the exterior member partially covers the functional member, or in a functional component bonded with the functional member as a bonding partner.

The effects described in the embodiment of the present embodiment are merely the most preferable effects generated from the present embodiment, and the effects of the present embodiment are not limited to those described in the embodiment of the present embodiment.

According to the liquid discharge head of the present embodiment, the bonding strength between the frame and the cover can be increased.

A liquid discharge head includes: a head including: a nozzle plate having nozzles arrayed in a first direction to discharges a liquid, from the nozzles, in a second direction orthogonal to the first direction; and a frame including: a snap-fitted part; and a bonded part; and a cover attached to the frame of the head in the second direction, the cover including: a snap-fitting part fitted to the snap-fitted part of the frame of the head; a bonding part bonding to the bonded part of the frame of the head with adhesive, and the bonding part is positioned more internally than an inner circumferential face of the cover; and the bonding part is spaced apart from the snap-fitting part. The bonding part is positioned more internally than the snap-fitting part of the cover that is snap-fitted to the snap-fitted part of the frame of the head.

The frame includes a base; and a projection projected from the base and having: a distal end having the bonded part; and the snap-fitted part between the base and the distal end in the second direction, and the cover includes: the snap-fitting part including a hook engageable with the snap-fitted part of the frame; and an abutment part abutted to and bonded to the bonded part of the distal end of the projection of the frame with the adhesive, and the abutment part is positioned more internally than the hook in a third direction orthogonal to the first direction and the second direction.

The projection of the frame is formed along an outer circumferential face of the frame and positioned more internally than the outer circumferential face of the frame, the projection includes snap-fitted parts including the snap-fitted part in side faces of the projection in the first direction and the third direction, and the cover includes hooks including the hook in the outer circumferential face of the cover in the first direction and the third direction.

The projection has a two-stage projection having: a first projection having a first projection amount on the base; and a second projection on the first projection having a second projection amount smaller than the first projection amount, an outer circumferential face of the second projection is positioned more internally than an outer circumferential face of the first projection, the first projection has the snap-fitted part on the outer circumferential face, and the second projection has the bonded part on a distal end of the second projection.

The second projection has a first distance between side faces of the distal end of the second projection in the third direction, and the cover has hooks having the hook in each side faces of the cover in the third direction, and the hooks are separated with a second distance larger than the first distance in the third direction. The snap-fitted part on the first projection has a recess engageable with the hook of the cover, and the bonded part on the distal end of the second projection is separated from the recess of the first projection in the second direction.

The cover has another abutment part extending from the snap-fitting part toward the frame in the second direction, the frame has another bonded part at a leading end of the base in the second direction, and said another abutment part of the cover abutted to and bonded to said another bonded part of the base of the frame with the adhesive. The cover has an extension part extending from the snap-fitting part toward the frame in the second direction, the frame has recess on a distal end of the frame to be fitted to the extension part.

A liquid discharge device includes: the liquid discharge head, and a head tank attached to the liquid discharger head to supply the liquid to the liquid discharge head. A liquid discharge apparatus includes: the liquid discharge device; and a conveyor to convey a medium to the liquid discharge device.

A functional component includes: a first part including a frame including: a snap-fitted part; and a bonded part; and a second part attached to the frame of the first part in a fitting direction, the second part including: a snap-fitting part fitted to the snap-fitted part of the frame of the first part; a bonding part bonding to the bonded part of the frame of the first part with adhesive. The bonding part is disposed, in a direction orthogonal to the fitting direction: positioned more internally than an outer circumferential face of the second part; and positioned more internally than the snap-fitting part of the second part snap-fitting to the snap-fitted part of the frame of the first part.

The above description is an example, and the present embodiment has unique effects for each of the following aspects. In the description of the aspects, the reference numerals in parentheses after the component names are examples of corresponding members, and are not limited to these examples of members.

### Aspect 1

According to Aspect 1, a liquid discharge head (100) includes a head (101) that discharges a liquid; and a cover (102) attached to a frame (170) of the head (101), the frame (170) and the cover (102) being joined by snap-fit engagement and adhesive bonding, and a point of the adhesive bonding being on an inner peripheral part of the cover (102), the point away from a point (221a) of the snap-fit engagement toward an inner back side of the cover (102). According to this, as described in each embodiment with reference to the drawings, the bonding strength between the frame and the cover can be increased.

### Aspect 2

According to Aspect 2, in the liquid discharge head (100) of Aspect 1, the frame (170) includes a projection (220) extending along an outer peripheral shape line (170a) inside the outer peripheral shape line (170a) at a point facing the cover (102), and an engaging frame part (221) for the snap-fit engagement formed on an outer peripheral side surface of the projection (220) at a point away from a projection distal end face (220a), and the cover (102) includes an engaging cover part (210) that snap-fit engages with the engaging frame part (221), and an adhesive abutment part (230) that abuts the projection distal end face (220a, 240a) to be adhesively bonded in a snap-fit engaging state with the frame (170). According to this, as described regarding the first embodiment, the outer shape of the cover (102) can be downsized.

### Aspect 3

According to Aspect 3, in the liquid discharge head (100) of Aspect 2, the projection (220) is a two-stage projection having a larger projection amount on an inner side, the engaging frame part (221) is provided on an outer peripheral side surface of an outer first-stage projection (220) having a smaller projection amount, and a distal end face (240a) of an inner second-stage projection (240) having a larger projection amount abuts the adhesive abutment part (230) of the cover (102). According to this, as described regarding the second embodiment, it is possible to avoid the snap-fit hook (210) from touching the adhesive of the partner at the time of bonding.

### Aspect 4

According to Aspect 4, in the liquid discharge head (100) of any one of Aspects 1 to 3, an adhesive-present point of the adhesive bonding is a point with which a hook (210) does not come into contact during approach of the frame (170) and the cover (102) for bonding, the point inside an outer peripheral shape line, at a facing point in one including a hook engaging part (221) engaged with the hook (210) of snap-fit engagement out of the frame (170) and the cover (102) when being bonded to the other of the frame (170) and the cover (102). According to this, as described regarding the second embodiment, it is possible to avoid the snap-fit hook (210) from touching the adhesive of the partner at the time of bonding.

### Aspect 5

According to Aspect 5, in the liquid discharge head (100) of Aspect 4, the point that does not come into contact is a distal end face (220a, 240a) of a projection (220, 240) at the facing point. According to this, as described regarding the second embodiment, it is possible to avoid the snap-fit hook (210) from touching the adhesive of the partner at the time of bonding, and it is possible to avoid difficulty in adjusting the adhesive application range.

### Aspect 6

According to Aspect 6, in the liquid discharge head (100) of any one of Aspects 1 to 5, the cover (102) includes an extension part (250) extending toward the frame (170) from a distal end of an engaging cover part (210) for the snap-fit engagement, and the extension part (250) is also adhesively bonded to the frame (170). According to this, as described regarding the third embodiment, entry of liquid mist can be suppressed.

### Aspect 7

According to Aspect 7, in the liquid discharge head (100) of any one of Aspects 1 to 6, the cover (102) includes an extension part (270) extending toward the frame (170) from a point of the snap-fit engagement, and a distal end of the extension part (270) is fitted in a fitting recess (260) on the frame (170). According to this, as described regarding the fourth embodiment, the outer peripheral part of the cover (102) is accommodated in the fitting recess (260) of the frame (170), so that this is strong against the force in the rotation direction, and bonding strength is improved.

### Aspect 8

According to Aspect 8, a liquid discharge device includes the liquid discharge head (100) of any one of Aspects 1 to 6.

### Aspect 9

According to Aspect 9, a liquid discharge apparatus includes the liquid discharge head (100) of any one of Aspects 1 to 7, or the liquid discharge device of Aspect 8.

### Aspect 10

According to Aspect 10, a functional component (100) includes a functional member (101) for exhibiting a function; and an exterior member (102) covering the functional member (101), the exterior member (102) being bonded to another exterior member partially covering the functional member (101) or the functional member (101) as a bonding partner, the bonding partner and the exterior member (102) being joined by snap-fit engagement and adhesive bonding, and a point of the adhesive bonding being on an inner peripheral part of the exterior member (102), a point away from a point (221a) of the snap-fit engagement toward an inner back side of the exterior member (102). According to this, it is possible to increase bonding strength, and in particular, it is possible to avoid failure due to joint break of a functional component used in an environment in which a liquid that breaks bonding by an adhesive exists.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a head including:
a nozzle plate having nozzles arrayed in a first direction to discharges a liquid from the nozzles, in a second direction orthogonal to the first direction; and
a frame including:
a snap-fitted part; and
a bonded part; and
a cover attached to the frame of the head, the cover including:
a snap-fitting part fitted to the snap-fitted part of the frame of the head;
a bonding part bonding to the bonded part of the frame of the head with adhesive,
wherein the bonding part is positioned more internally than an inner circumferential face of the cover; and
the bonding part is spaced apart from the snap-fitting part.

2. The liquid discharge head according to claim 1,
wherein the bonding part is positioned more internally than the snap-fitting part of the cover that is snap-fitted to the snap-fitted part of the frame of the head.

3. The liquid discharge head according to claim 1,
wherein the frame includes:
a base; and
a projection projected from the base and having:
a distal end having the bonded part; and
the snap-fitted part between the base and the distal end in the second direction, and
the cover includes:
the snap-fitting part including a hook engageable with the snap-fitted part of the frame; and
an abutment part abutted to and bonded to the bonded part of the distal end of the projection of the frame with the adhesive, and
the abutment part is positioned more internally than the hook in a third direction orthogonal to the first direction and the second direction.

4. The liquid discharge head according to claim 3,
wherein the projection of the frame is formed along an outer circumferential face of the frame and positioned more internally than the outer circumferential face of the frame,
the projection includes snap-fitted parts including the snap-fitted part in side faces of the projection in the first direction and the third direction, and
the cover includes hooks including the hook in the outer circumferential face of the cover in the first direction and the third direction.

5. The liquid discharge head according to claim 3,
wherein the projection has a two-stage projection having:
a first projection having a first projection amount on the base; and
a second projection on the first projection having a second projection amount smaller than the first projection amount,
an outer circumferential face of the second projection is positioned more internally than an outer circumferential face of the first projection,
the first projection has the snap-fitted part on the outer circumferential face, and
the second projection has the bonded part on a distal end of the second projection.

6. The liquid discharge head according to claim 5,
wherein the second projection has a first distance between side faces of the distal end of the second projection in the third direction, and
the cover has hooks having the hook in each side faces of the cover in the third direction, and
the hooks are separated with a second distance larger than the first distance in the third direction.

7. The liquid discharge head according to claim 6,
wherein the snap-fitted part on the first projection has a recess that is engageable with the hook of the cover, and
the bonded part on the distal end of the second projection is separated from the recess of the first projection in the second direction.

8. The liquid discharge head according to claim 3,
wherein the cover has another abutment part extending from the snap-fitting part toward the frame in the second direction,
the frame has another bonded part at a leading end of the base in the second direction, and
said another abutment part of the cover abutted to and bonded to said another bonded part of the base of the frame with the adhesive.

9. The liquid discharge head according to claim 1,
wherein the cover has an extension part extending from the snap-fitting part toward the frame in the second direction,
the frame has recess on a distal end of the frame to be fitted to the extension part.

10. A liquid discharge device comprising:
the liquid discharge head according to claim 1, and
a head tank attached to the liquid discharger head to supply the liquid to the liquid discharge head.

11. A liquid discharge apparatus comprising:
the liquid discharge device according to claim 10; and
a conveyor to convey a medium to the liquid discharge device.

12. A functional component comprising:
a first part including a frame including:
a snap-fitted part; and
a bonded part; and
a second part attached to the frame of the first part in a fitting direction, the second part including:
a snap-fitting part fitted to the snap-fitted part of the frame of the first part;
a bonding part bonding to the bonded part of the frame of the first part with adhesive,
wherein the bonding part of the first part is positioned more internally than an inner circumferential face of the second part; and
the bonding part of the first part is spaced apart from the snap-fitting part of the second part.
